(19) United States
(12) Patent Application Publication
(10) Pub. No.: US 2002/0074771 A1
(43) Pub. Date: Jun. 20, 2002

(54) Multi linking leverage suspension system

(76) Inventor: Greg M. Parigian, Chatsworth, CA (US)

Correspondence Address: Greg M. Parigian, 10446 Variel Ave., Chatsworth, CA, 91311, US

(21) Appl. No.: 09/740,517

(22) Filed: Dec. 19, 2000

(51) Int. Cl. B62K 11/02

(52) U.S. Cl. 280/286; 180/227

(57) ABSTRACT

A new design and formula for enhanced rear suspension movement. This new invention of the multi linking, design incorporates twin non transverse upper and lower swing arms with a stabilizing link that forms a open configuration. I have built a prototype and studied other designs and found that my invention would not operate without the third stabilizing link to control the pivoting arm. This link is adjustable to set angle of axle support carriage and to support it as it moves. I have not found any other designs that function in this manner. The feature of the invention comes from the connection of the axle support carriage by two links and a stabilizing link that provides leverage for a live suspension system.

### DESCRIPTION

This invention relates to the rear suspension system of two wheeled vehicles motorcycles and bicycles.

The existing designs of the two wheeled rear suspension systems are typically of a pivoting one point connection to the frame. This system incorporates a swing arm assembly with a shock spring unit to the frame that controls the movement of the swing arm assemble. Additional designs incorporate the same swing arm assemble but have a second swing arm that produces a design called a quad configuration.

The design system I have invented substantially improves rear wheel geometry. This movement whereby controls the wheel contact to the pavement and the connection to the frame. Testing of this system in high performance applications improves stability of the rear wheel control compared to all other existing designs. Since improvement in high performance vehicles may be a great benefit this may also provide additional safety in every day uses.

Safety of control translates from the transferred ability of increased stopping control. This system will not wobble back and forth as existing designs may occur. Under acceleration this system will contain the power and not transfer force back to the front end of the vehicle. This design as described above greatly improves the torsional value of the complete frame unit as a whole.

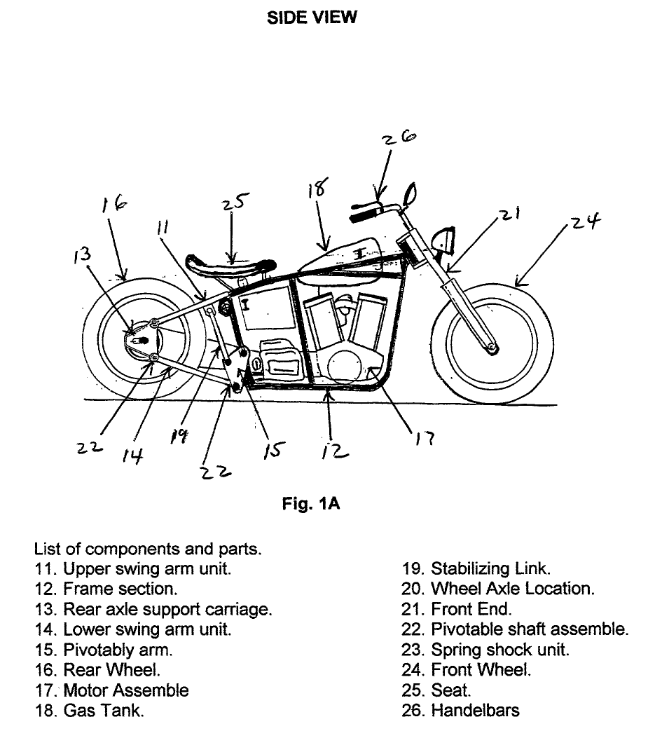

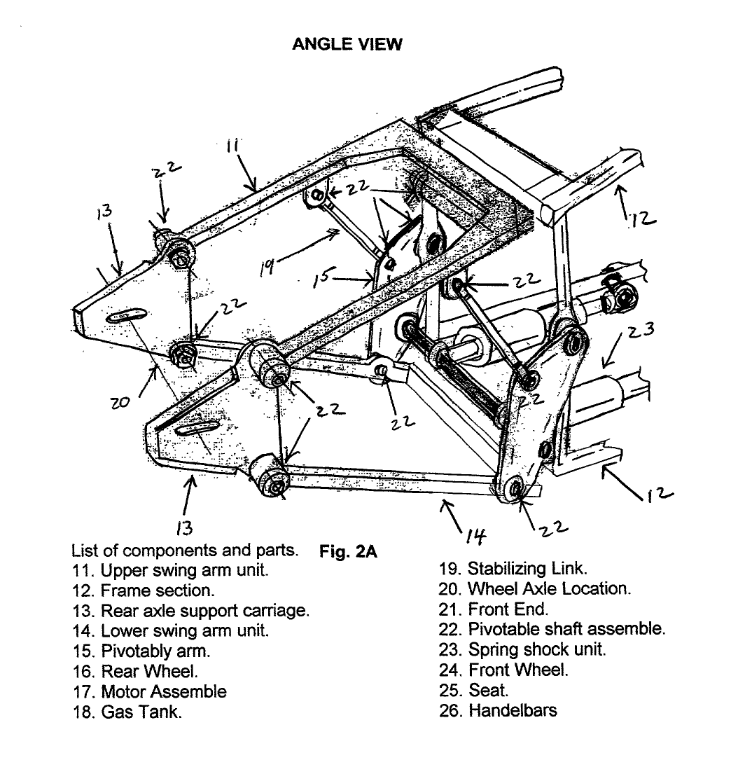

I have provided drawings designed with standard tube frame design showing the configuration of what I call the Multi Linking Leverage Suspension System. In these drawings I will first show a motorcycle having this type of rear suspension system FIG. 1A. In FIGS. 2A, 3A and 4A show the respective designs with details of parts of FIG. 1A for total conceptual rendition of design.

Starting with FIG. 1A shows a dual under frame shock spring assemble and FIG. 2A showing the angle view of the shock spring assemble. My intention is to focus on the FIG. 2A design for the typical method of operations of the invention. The illustration on page 7 FIG. 2A shows the components of the Multi Linking suspension system. I will describe the parts and their function in the order of operation.

FIG. 2A part 11, upper swing arm pivots via part 12 frame section with either bushings or roller bearings in enclosed tube sections or in a manner that thereby pivots in a respective way. This upper swing arm pivots also from the rear axle support carriage in the same manner. This upper swing arm shall be known as the primary support for the axle support carriage.

FIG. 2A part 16, Stabilizing Link function in the same manner as the upper swing arm. Their pivot able direction is corresponding with the upper swing arm actions. Their usage is to keep the rear axle support carriage in a vertical plane in the upward and downward motions. The stabilizing link locations on the corresponding parts actuate the leverage design of this system. The multitude of locations of the stabilizing link tranferes to the related parts for desired movement for desired ride control. The connections to the Pivot able shaft assembly unit and upper swing arm unit may use either a heim joint or pivot controls as in upper swing arm pivot joints.

FIG. 2A part 14, lower swing arm functions in the same manner as in the upper swing arm except that it pivots from part 15. the lower swing arm pivot arm. This connections enables the complete assemble to work as one in the upward and downward motion. The diverse design enables the lower and upper swing arm to be separated to not form a complete link. The complete configuration may be constructed in the opposite, upside down configuration so that the shocks are mounted on to of the main frame section.

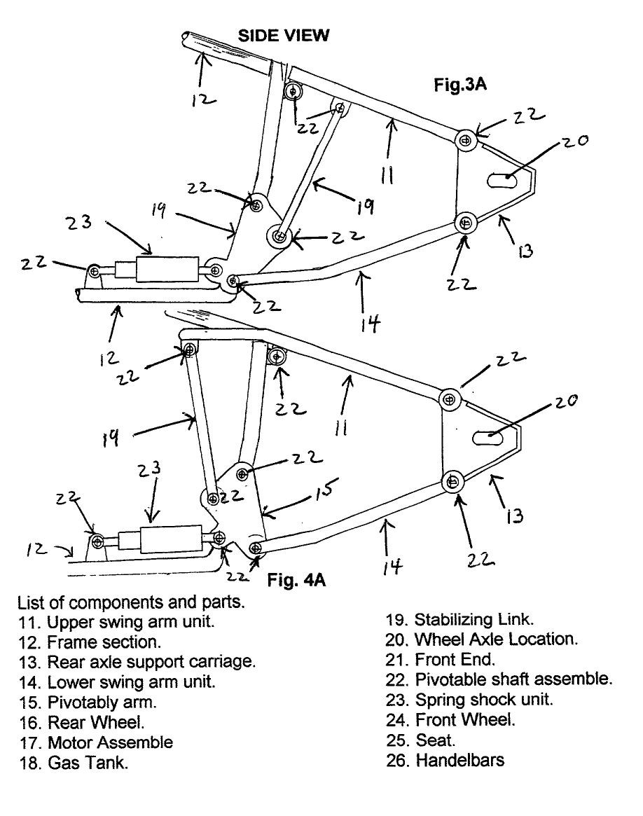

FIG. 3A part 13, the rear axle support carriage unit supports the axle which in turn the wheel assemble is supported. The axle support carriage pivots from the upper and lower swing arms. The primary function of the axle support carriage is the connection of all support units combining one fluid motion in the upward and downward motion. The connection of all support units as which has been described respectively.

FIG. 3A part 20, the spring shock unit is supported by the pivotably part 15 and to the part 12 frame section. As the swing arms and axle support carriage move the shock spring unit controls the amount of movement. Depending on the rate of the spring in relation to the location of the spring unit mounted on the swing arm increases or decreases the leverage required for movement.

FIG. 3A is respectively of FIG. 4A shows the assemble in a side views. FIGS. 3A and 4A shows the different locations of the stabilizing link configurations. This ability may also constructed in an upside down configuration and still operate in the same manner.

### LIST OF COMPONENTS AND PARTS

11. Upper swing arm unit.

12. Frame section.

13. Rear axle support carriage.

14. Lower swing arm unit.

15. Pivotably arm.

16. Rear Wheel.

17. Motor Assemble

18. Gas Tank.

19. Stabilizing Link.

20. Wheel Axle Location.

21. Front End.

22. Pivotable shaft assemble.

23. Spring shock unit.

24. Front Wheel.

25. Seat.

26. Handelbars

1. Designed for any two wheeled vehicle either motorized or not this opposing angled rear suspension design functions with non transverse swing arms. The lower pivot arm/connects the lower swing arm and the frame structure as a pivoting link connection point. This connection point is one location that a spring shock unit may be installed that has the correct spring pressure and shock pressure to actuate movement times the weight of the assemble. Either a mono shock unit or twin shock unit may be utilized. The upper swing arm is directly pivoting from the frame structure. The stabilizing links maintain the angle and pitch of the rear axle shaft support carriage.

2. This designed system may also be repositioned in the reverse layout with the pivot link mounted to the upper swing arm assembly. Having the stabilizing link assemble pivoting from the oposing side of the upper swing arm.

3. A two wheeled vehicle frame assemble having twin non transverse angled rear suspension swing arms. Shock spring units may be mounted to all areas that produce proper forces to counter act the upward presure of force of the wheel direction. Rear suspension design composing of a multi linking rear axle support members support members for maximum control strength of the rear wheel.

4. A two wheeled vehicle frame assemble with shock spring units that move with a ratio that can be altered with location to change the ratio of pressure to the axle shaft support member. Connection of spring shock units connected with a pivioting link changing the ratio of movement of the swing arms.

5. A two wheeled vehicle frame assemble with muliple shock spring unit locations that move with adjustable ratio as the axle shaft support member supports a wheel assemble. Connection of the spring shock unit connected to the swing arm units that applie counter acting leverage forces.

6. The multi linking leverage suspension system claims for maximum stability of rear wheel connections to frame and contact with surface on which two wheeled vehicle may roll on. Minimizes twisting and flexing of rear wheel support carriage. A complete change and improvement to the existing two wheeled single swing arm and dual quad swing arm configuration.
